(19) United States
(12) Patent Application Publication
(10) Pub. No.: US 2018/0342017 A1
(43) Pub. Date: Nov. 29, 2018

(54) SYSTEM AND METHOD FOR DIRECT INVESTING

(71) Applicant: NAV.VC, Reston, VA (US)

(72) Inventor: John Carlton Backus, JR., Great Falls, VA (US)

(21) Appl. No.: 16/024,378

(22) Filed: Jun. 29, 2018

Related U.S. Application Data
(62) Division of application No. 15/047,611, filed on Feb. 18, 2016.
(60) Provisional application No. 62/117,945, filed on Feb. 18, 2015.

(51) Int. Cl. G06Q 40/06; H04L 29/06; G06F 17/30; G06Q 40/02

(52) U.S. Cl. CPC G06Q 40/06; H04L 63/102; G06Q 40/02; G06F 17/3053

(57) ABSTRACT

In one embodiment, a method comprising receive a list of one or more companies that one or more firms have invested in, analyze one or more companies based on an algorithm, where the algorithm comprises one or more parameters of percentage ownership, timing and size of a next financing, size of pro rata rights of the next financing, and projected financials, assign the one or more companies a first ranking based on the analysis, compare the first ranking with a second ranking of the one or more companies received from a third party database, and assign a third ranking based on the comparison of the first ranking and the second ranking.

### CROSS-REFERENCE TO RELATED APPLICATIONS

This application is a divisional of application Ser. No. 15/047,611 filed on 18 Feb. 2016 which is a continuation-in-part and claims the benefit of U.S. Provisional Application No. 62/117,945, entitled “Pro Rata Opportunity Fund”, filed 18 Feb. 2015, the entirety of which is incorporated by reference as if fully set forth herein.

### TECHNICAL FIELD

This disclosure generally relates to private equity investments and more specifically relates to accessing highly competitive investment either directly or through a portfolio structure.

### BACKGROUND

The venture capital industry is generally characterized by two types of investors: (1) early stage investors; and (2) later stage investors. Early stage investors take significant risk with young businesses as to their ultimate success because more than half of early stage venture backed businesses fail. The young businesses that succeed often raise a substantial amount of money, resulting in significant ownership dilution for the early stage investors. Later stage investors compete to access the most successful companies and may not be able to invest in the companies in which they are most interested.

### BRIEF DESCRIPTION OF THE DRAWINGS

FIG. 1 illustrates an example chart showing enterprise value versus ownership value in accordance with preferred embodiments of the present invention.

FIG. 2 illustrates an example PROOF portfolio in accordance with preferred embodiments of the present invention.

FIG. 3 illustrates an example venture in accordance with preferred embodiments of the present invention.

FIG. 4 illustrates an example strategy for PROOF in accordance with preferred embodiments of the present invention.

FIG. 5 illustrates an example network environment in accordance with preferred embodiments of the present invention.

FIG. 6 illustrates an example computer system in accordance with preferred embodiments of the present invention.

### DESCRIPTION OF EXAMPLE EMBODIMENTS

Successful early stage venture capital portfolios generally have fewer than five very successful companies out of approximately 25 total investments. Later stage venture capital portfolios have more winners per number of investments, yet the size of each win may not be as big because once it is obvious that a young business will be great, later stage investors will be competing with many other investors for the opportunity to invest in that young business. The Pro Rata Opportunity Fund (“PROOF”) will build a portfolio largely comprised of winning companies, with many fewer losing companies than the typical VC portfolio, without having to wonder about the ability to access these successful companies. This may offer investors the opportunity to obtain ownership in many of the most successful growth stage companies from the portfolios of top performing US venture capital funds, without having to invest through a hard-to-access venture fund, and without having to also invest in the unsuccessful companies in each fund.

A typical venture capital fund has 20-25 companies in a portfolio which are selected over a 36-48 month period. Out of this portfolio, 1-5 companies often deliver the bulk of the returns to limited partners. For example, 80% of the value in a venture portfolio comes from 20% of the companies. These breakout companies often raise very large financing rounds to consolidate and solidify their market positions. The challenge for most venture capital firms, especially seed, early-stage, and expansion round investors, is that they are not able to maintain their pro rata ownership in these later stage financing rounds. The average number of years from company formation to the initial public offering has increased from about 4 years to over 8 years, doubling in 20 years. Most successful companies raise bigger rounds (tripling in 20 years). Although these early investors almost always have the absolute right, via pre-negotiated pro rata rights, to maintain their ownership percentage in subsequent financing rounds, these investors almost always let some or all of these rights expire worthless in later stage financing rounds, lacking the capital to invest using this right.

Many portfolios are built around diversification of 25-50 companies where an average of 2-5% may be allocated to any one company and capital reserves must be maintained for all promising active companies. Limited partnership agreements may also contractually prohibit concentration in any one company. For example, 10% limits are common. Early stage venture capital portfolios may target 10-20× returns on each investment whereas later stage venture capital portfolios may target 2-3× returns per investment.

A traditional venture fund will take its losses on a given portfolio of twenty to twenty five investments and earn them back with their gains before calculating their carried interest. The carried interest is the primary way a venture capital firm makes money. There are firms in the VC business that take 20-30% carry. There are investors who get a “deal by deal carry.” In that model they do not have to account for their losses in the calculation of carry. So they take 20% on their successful deals and don't have to net out their losses. Another thing about deal by deal carry is how it changes the incentives. If investors don't have to worry about the ⅔ of the portfolio that produces disappointing outcomes, they will pay all of their attention on the winners and work to make those investments as successful as possible. That might be good. The VC economics already trend toward incentivizing that behavior because all of the gains come from a small portion of the portfolio. Deal by deal carry just amplifies that.

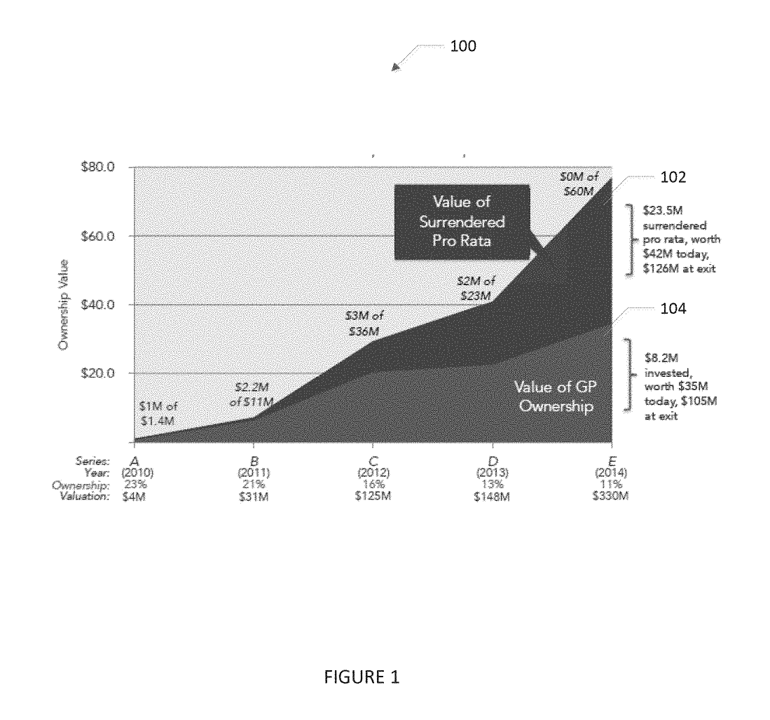

FIG. 1 illustrates an example chart 100 showing enterprise value versus ownership value. Chart 100 illustrates the ownership value of surrendered pro rata rights 102 and general partner (“GP”) ownership value 104. In 2014, for example there was an estimated opportunity to capture $16 billion of ownership value via surrendered pro rata rights, or about 10% of the total enterprise value created, assuming these investors had access to another $4 billion of capital to invest.

In particular embodiments PROOF may build a relationship-based deal flow network between PROOF and one or more venture capital (“VC”) firms and funds, or network VCs. VCs may include, but are not limited to, seed and early stage VC funds, angel investors, corporate VCs, and micro VC funds. In particular embodiments, these relationship may allow PROOF to source the best deals from these venture capital firms. In particular embodiments, these relationships may be formal and informal. In particular embodiments, PROOF may work with early-stage and expansion stage venture capital funds to use their existing pro rata rights in breakout companies to invest directly in these companies. In particular embodiments, PROOF may retain the absolute right to invest in future rounds of breakout companies from the network VCs.

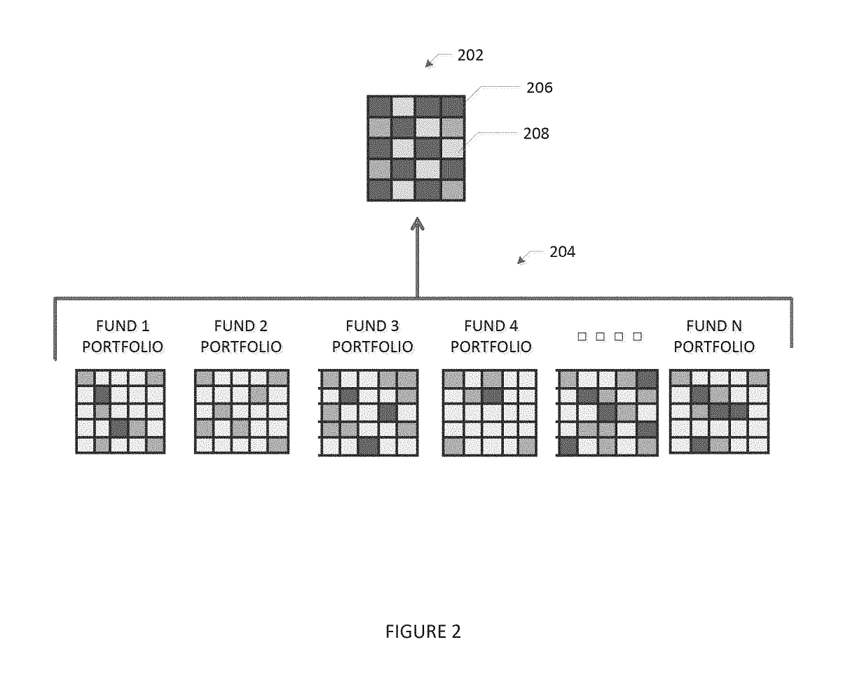

By building a relationship-based deal flow network, PROOF may create a synthetic VC portfolio of 750-1000 companies, from which PROOF may be able to select the top 25-50 companies for potential investment. FIG. 2 illustrates an example PROOF portfolio 202 comprising approximately 20 breakout companies 206 and 30 average companies 208 out of 50 total companies within the portfolio. The PROOF portfolio 202 was created by investments in approximately 1-5 breakout companies 206 from one or more VC portfolios 204, where each of the funds in the VC portfolios 204 have about 25 total companies that include breakout companies 206 and average companies 208. In particular embodiments Partner VCs may invest in 100-200 new companies each year, and the GPs of these funds will at any point in time have between 500-1000 companies in their collective portfolios. In particular embodiments, PROOF may invest in 10-20 companies annually.

In particular embodiments of the present invention where PROOF chooses to invest in one or more of the top 25-50 companies, PROOF may be able to invest without competing to be selected as a new investor because PROOF may partner with the GP and may use the GP's pro rata rights to make an investment. Pro rata rights may be any right that the GP has in a company where the GP is entitled to maintain its percent ownership in subsequent funding rounds. In particular embodiments, PROOF use its partner's pro rata rights either informally or formally using a special purpose investment vehicle (“SPV”). In particular embodiments, the SPV may be managed by PROOF and the GP or the network VC may also be a member of the SPV. In particular embodiments the SPV may qualify as an affiliate under particular pro rata language.

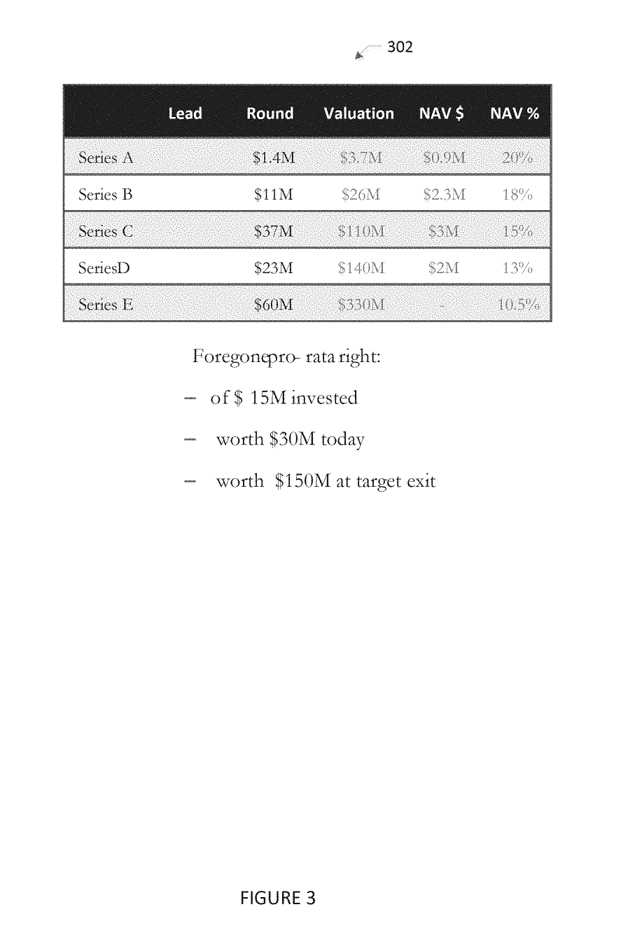

These investment rounds are likely to be the last (or next to last) investment rounds for new investors to invest in these companies, before they are acquired or go public via an initial public offering. The opportunity for multiple new investors to enter in these late stage rounds will be limited, as these rounds typically are lead by one marquee, outside, lead investor. FIG. 3 illustrates example venture 302 where there is a significant foregone pro rata right.

In particular embodiments, PROOF may co-invest with other top tier funds if and to the extent that the investment is determined to be attractive and suitable. In particular embodiments, PROOF may gain access to these investment opportunities by taking advantage of pre-emptive investment rights to which other network VCs or funds are entitled, and which other funds have elected to not utilize, or other available allocation in these financings. In particular embodiments, PROOF may invest in portfolio companies that have demonstrated both strong performance and high potential, or evidence of market traction. PROOF may target its investments to companies with one or more of the following characteristics: (a) revenue greater than $25 million; (b) positive EBITDA; (c) annual revenue growth greater than 100%; (d) enterprise value greater than $100 million; (e) category leadership; (f) multiple investment offers from current and new investors; (g) ongoing investment participation by current investors; (h) investment terms established by well-respected outside, financially motivated investors, and supportable by market evidence; and (i) Recognized as a market leader in a large market space (at least $1 billion).

In particular embodiments, each portfolio company will have a valuation that is well supported by observable market factors, such as a sophisticated and well respected outside investor is leading the investment and competing term sheets to invest in the round have been offered, or the round is oversubscribed.

In particular embodiments, Partner VCs may fall in to one or more of three groups: Venture Capital Firms, Corporate VCs, and Angel Investors. Potential Partner VCs are on the ground with offices in the key venture capital markets of Atlanta, Boston, New York City, San Francisco, Seattle, Silicon Valley, Washington, DC, Chicago, Austin, and Los Angeles.

The Proof Fund will invest in portfolio companies of top performing venture capital funds in the USA and in other countries as determined by the General Partner. The identified potential network VCs have backed many of the top technology companies of the last 20 years.

In particular embodiments there may be shared economics between PROOF and the originating GP. For example, there may be carried interest sharing. In particular example embodiments, there may be carried interest sharing immediately upon exit on a deal carry basis as opposed to at the fund level. In particular embodiments, carried interest sharing may incentivize the originating GP to share their best deals, as they may make additional income via carried interest sharing only if they share their good deals. In particular embodiments a hybrid economic structure may comprise a 10% deal carry for PROOF's partner GPs with a 10% fund level carry for the PROOF GP.

In particular embodiments, PROOF may analyze potential investments and make funding commitments before these companies officially come to market. This may enable PROOF's partner GPs to lock-in their pro rata rights before any financings decisions have begun. This may be very important in particular embodiments because once term sheets are received, for example in one or more rounds of financing, if an early VC with pro rata rights then tries to assert them, a confrontation within the investor group and the board may ensue. In particular embodiments, investments may be pre-approved because it may be important to move at the quick pace of an investment round.

In particular embodiments, PROOF may vote its shares with partner GPs so long as there is not a conflict between the interests of the preferred stock class and the young business' earlier classes of stock. In particular embodiments, PROOF may compile a master database of all partner GP companies, and cross reference with other industry databases and analytics platforms. In particular example embodiments, industry databases may be those like Mattermark, Pitchbook, Preqin, or others. In particular example embodiments, analytics platforms may be those like Compete. In particular embodiments, the master database may enable discovery of potentially high performing companies in the partner GP portfolios at the earliest stages as well as new network VCs with a strong portfolio of high potential companies.

In particular embodiments, once an ownership position has been established in a company, PROOF may add to it through the purchase of shares on the secondary market. The secondary market may include employees, founders, and other selling shareholders. The company in which PROOF is investing may see PROOF as a friendly investor because PROOF is already listed on the cap table.

There may be one or more terms of investment for similar companies. In particular embodiments, the GP of PROOF may have sole discretion in selecting portfolio companies. The PROOF GP may decide to not invest in companies that meet the above criteria, or it may authorize an investment in a company that does not meet some of the above criteria.

In particular embodiments, PROOF may establish reserves of approximately $3 for each $1 of initial investment. This may be appropriate for follow-on financing needs where some companies only need one round of financing from PROOF, and in some situations, some companies may need two or more rounds of financing.

PROOF may use its funding to support the portfolio companies of its partner VCs. The General Partners at its Partner VCs have previously evaluated these companies. While many investments in the Opportunity Fund Companies are potentially high-return investments, they will involve significant uncertainty and financial risk because these companies are growth-stage technology companies that have limited operating histories and may or may not be currently operating at a loss. For additional risks associated with investing in the Opportunity Fund Companies, see “Risk Factors.”

We expect that a representative of the General Partner of our Partner VCs will serve on the Board of Directors (or as an observer) of most of the Opportunity Fund Companies, and that they will continue to provide significant support to the Opportunity Fund Companies to help them realize their full potential. The Opportunity Fund will enhance the Partner VCs General Partner's ability to support and guide the Opportunity Fund Companies by enabling each partner VC to hold a larger aggregate ownership position and play a larger role in future financing rounds. The General Partner may agree to enter into a voting agreement with its Partner VCs where it agrees to vote its shares on corporate matters in concert with the votes of the Partner VCs.

In particular embodiments, eventual liquidation of PROOF's investment in its portfolio companies is typically achieved by way of a merger and acquisition or public offering. In particular example embodiments, as a result of merger and acquisition or public offering, all of the securities of the portfolio company become tradable (subject to normal delays and limitations) or are exchanged for merger and acquisition consideration. In particular example embodiments, a portion of a portfolio company's securities may be sold to a private buyer. Where a portion of a portfolio are sold to a private buyer, in particular embodiments, PROOF may at its sole discretion will decide what securities from the Opportunity Fund will be sold.

In particular embodiments, PROOF may be highly successful, as indicated by key performance metrics. Key performance metrics may include substantial capital commitments, investments in companies that have a successful IPO, including a high market value, or are acquired for cash, or that result in cash proceeds, a quick return of capital, and a high net value to investors, including high IRR, high total value over paid-in capital, and high distributions over paid-in capital.

In particular embodiments, one or more existing tools and databases may be integrated and one or more matching algorithms may be incorporated that may highlight interesting companies in which to invest. Companies may be input into a database of companies that Partner VCs and angels have invested in. An algorithm may include special parameters, such as their percentage ownership, likely timing and size of next round, size of their prorata rights based in the expected round. In particular embodiments, projected financials may be incorporated in to the algorithm. PROOF or partner VC may add data to the database of companies.

In particular embodiments, the analysis of the companies is matches with external databases, such as crunchbase. This analysis may highlight the other investors in these companies. IN particular embodiments, data internally analyzed and data from external databases are merged, and absolute growth rate is analyzed for one or more users that may access the database. In particular embodiments, the companies may be dynamically ranked based on these metrics on an absolute level, on a relative level compared to the market and competition, and then compared to forecast where possible.

In particular embodiments, the output provides a target list of companies in which to begin the due diligence process. Once PROOF determines a company in which to invest, a reasonable valuation range based on market comparables is determined and a financing pre-commitment letter is prepared. In particular embodiments, a special purpose investment vehicle that we manage but that is an affiliate of our partner GP is created to perform the financing. In particular embodiments, once a position is established in a company, PROOF may look to add to that position by possibly identifying other selling shareholders including founders, employees, angels and early VCs.

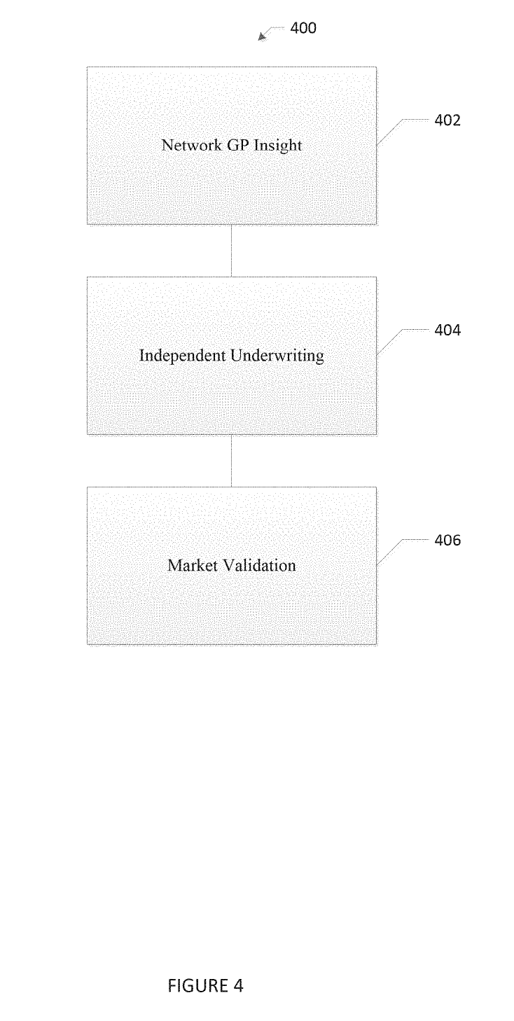

FIG. 4 illustrates an example strategy for PROOF 400. In particular embodiments, a strategy for PROOF comprises network GP insight 402. Network GP insight comprises leveraging insight, both legal and inside information, from a GP. Network GP insight comprises early look at the best companies of a GP portfolio and working closely with GP partners to look-ahead on the fundraising calendar. In particular embodiments, a strategy for PROOF comprises independent underwriting 404. Particular embodiments comprise using inside metrics (which is fundamentally sound business), a determination of whether there is significant traction based on the number of users, user engagement, user retention, and low churn. Particular embodiments comprise an ability to own the industry sector or category. Particular embodiments comprise a viable path to profitability, including a plan and desire to achieve profitability. Particular embodiments comprise a sound valuation, including a 3×-5× exit potential. In particular embodiments, a strategy for PROOF comprises market validation 406. Particular embodiments comprise outside signaling, such as avoiding adverse selection. Particular embodiments comprise an up-round with an outside lead. Particular embodiments comprise multiple financing offers. Particular embodiments comprise where the GP has a valid reason to forego prorate rights.

In particular embodiments, PROOF is a private equity fund that combines fund level carry with deal level carry. Particular embodiments can offer deal carry to third parties of many types, including VC funds and angels. Particular embodiments pay the deal carry on every dollar we invest in the company, across many rounds. In particular embodiments, PROOF is a private equity fund that acts as a synthetic fund-of-funds, sitting on top of 20-50 other funds, but without necessarily investing in the underlying funds, thus avoiding such drawbacks as duplicate layer of fees, investments in early, underperforming companies, long J curve by deploying capital to rounds over 3-4 years where the funds themselves deploy capital each over 3-4 years.

A private equity system as opposed to a fund that that combines fund level carry with deal level carry. Particular embodiments can offer deal carry to third parties of many types, including VC funds and angels. Particular embodiments pay the deal carry on every dollar we invest in the company, across many rounds. In particular embodiments, PROOF is a private equity system, as opposed to a fund that acts as a synthetic fund-of-funds, sitting on top of 20-50 other funds, but without necessarily investing in the underlying funds, thus avoiding such drawbacks as duplicate layer of fees, investments in early, underperforming companies, long J curve by deploying capital to rounds over 3-4 years where the funds themselves deploy capital each over 3-4 years.

In particular embodiments, PROOF may be a private equity system, as opposed to a fund, that helps current investors in PE funds select the best companies out of those funds and then asserts the right to invest on behalf of the current PE fund investor. In particular embodiments, PROOF may be a PE fund that invests in underlying breakout companies via SPV 5 using Pro Rata.

In particular embodiments, PROOF may be a PE investing system, using Pro Rata that invests in breakout companies using SPV 5.

In particular embodiments, PROOF may be a PE fund where the GP does not write term sheets but gains access to the best deals via Pro Rata. In particular embodiments, PROOF may be a PE fund where the GP does not sit on boards but instead coverages the network VC to do so. In particular embodiments, the management fee could also be shared. In particular embodiments, additional fund level carry could also be shared.

In particular embodiments, giving conditional pre-approval of an investment to our network VC, before the company has formally begun raising around, may be subject to constraints, such as valuation, outside lead, quality of load, and whether the round is oversubscribed.

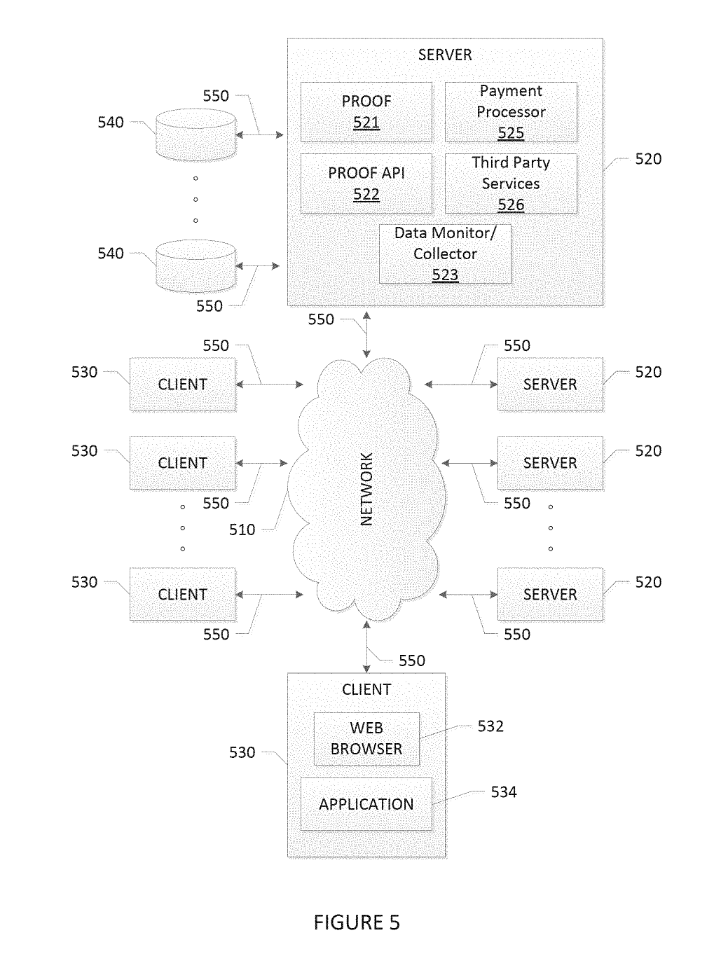

Particular embodiments may be implemented in a network environment. FIG. 5 illustrates an example network environment 500 suitable for managing a pro rata opportunity fund, private equity fund, or a private equity system. Network environment 500 includes a network 510 coupling one or more servers 520 and one or more clients 530 to each other. In particular embodiments, network 510 is an intranet, an extranet, a virtual private network (VPN), a local area network (LAN), a wireless LAN (WLAN), a wide area network (WAN), a metropolitan area network (MAN), a portion of the Internet, or another network 510 or a combination of two or more such networks 510. The present disclosure contemplates any suitable network 510.

One or more links 550 couple a server 520 or a client 530 to network 510. In particular embodiments, one or more links 550 each includes one or more wireline, wireless, or optical links 550. In particular embodiments, one or more links 550 each includes an intranet, an extranet, a VPN, a LAN, a WLAN, a WAN, a MAN, a portion of the Internet, or another link 550 or a combination of two or more such links 550. The present disclosure contemplates any suitable links 550 coupling servers 520 and clients 530 to network 510.

In particular embodiments, each server 520 may be a unitary server or may be a distributed server spanning multiple computers or multiple datacenters. Servers 520 may be of various types, such as, for example and without limitation, web server, news server, mail server, message server, advertising server, file server, application server, exchange server, database server, or proxy server. In particular embodiments, each server 520 may include hardware, software, or embedded logic components or a combination of two or more such components for carrying out the appropriate functionalities implemented or supported by server 520. For example, a web server is generally capable of hosting websites containing web pages or particular elements of web pages. More specifically, a web server may host HTML files or other file types, or may dynamically create or constitute files upon a request, and communicate them to clients 530 in response to HTTP or other requests from clients 530. A database server is generally capable of providing an interface for managing data stored in one or more data stores.

In particular embodiments, one or more data storages 540 may be communicatively linked to one or more severs 520 via one or more links 550. In particular embodiments, data storages 540 may be used to store various types of information. In particular embodiments, the information stored in data storages 540 may be organized according to specific data structures. In particular embodiment, each data storage 540 may be a relational database. Particular embodiments may provide interfaces that enable servers 520 or clients 530 to manage, e.g., retrieve, modify, add, or delete, the information stored in data storage 540.

In particular embodiments, each client 530 may be an electronic device including hardware, software, or embedded logic components or a combination of two or more such components and capable of carrying out the appropriate functionalities implemented or supported by client 530. For example and without limitation, a client 530 may be a desktop computer system, a notebook computer system, a netbook computer system, a handheld electronic device, a tablet computer, a mobile telephone, a slot machine, an internet-connected console, such as Xbox, Sony Playstation®, Nintendo®, Ouya, SteamBox, or other, any devices running iOS, Mac OS, Windows, Android, a wearable computer, such as Google Glass or similar device, or a virtual reality or augmented reality device, such as Oculus. The present disclosure contemplates any suitable clients 530. A client 530 may enable a network user at client 530 to access network 530. A client 530 may enable its user to communicate with other users at other clients 530.

A client 530 may have a web browser 532, such as MICROSOFT INTERNET EXPLORER, GOOGLE CHROME, MOZILLA FIREFOX, SAFARI, or OPERA and may have one or more add-ons, plug-ins, or other extensions, such as TOOLBAR. A user at client 530 may enter a Uniform Resource Locator (URL) or other address directing the web browser 532 to a server 520, and the web browser 532 may generate a Hyper Text Transfer Protocol (HTTP) request and communicate the HTTP request to server 520. Server 520 may accept the HTTP request and communicate to client 530 one or more Hyper Text Markup Language (HTML) files responsive to the HTTP request. Client 530 may render a web page based on the HTML files from server 520 for presentation to the user. The present disclosure contemplates any suitable web page files. As an example and not by way of limitation, web pages may render from HTML files, Extensible Hyper Text Markup Language (XHTML) files, or Extensible Markup Language (XML) files, Ruby-on-Rails, NodeJS, Scala, PHP, python, or java, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

A client 530 may have an application 534 that runs an in interface for managing PROOF. Application 534 may be written in native iOS, Android, Windows, HTMLS, Apple OS, C, C++, Flash, Java, Python, Rails, Scala, Unity, Windows OS or any other language specific to a particular client 530. Application 534 may be locally stored, cloud-based, streamed, downloaded, physical, or any combination thereof. Running application 534 may run the PROOF system locally or cause client 530 to communicate with PROOF API 522 that allows client 530 to communicate with PROOF 521 on server 520. Any action by a user to add or withdraw particular investments may prompt server 520 to interact with third party services 526. Third party services 526 may communicate with third parties for purposes of accessing additional PROOF related data. User, company, GP, VC data may be stored in data storages 540 and collected by data monitor/collector 523.

A client 530 may have a web browser 532, as described above, that renders a web page based on the files from server 520 for presentation to the user. A user may enter a PROOF platform via a web portal presented to the user on client 530. In particular embodiments, particular PROOF applications require particular compatibility with client 530. Client 530 may communicate directly with PROOF 521 on server 520. Server 520 may render one or more web pages based on the files from server 520 for presentation to the user. Server 520 may allow user to access one or more PROOF 521 on server 520.

A user may enter a PROOF platform through a user interface (UI). The UI may provide graphical input mechanism for allowing a user to retrieve list of top performing companies in which the user may want to invest. In particular embodiments, the UI may display the top several hundred companies offered by GPs based on network GP insight. The several hundred companies may be top performers, the network GP may be an early investor, there may be pro rata rights available, and the network GP may be investing in the current round. In particular embodiments, the UI may display a second screen displaying about a 100 companies that pass the underwriting analysis. The about 100 companies may be great companies and a great investment. The about 100 companies may be a category leader in a big market, have domstrated product and market fit, have revenue traction and visibility, have a fair valuation, and have world class founders. In particular embodiments, a third screen may display about 20 companies that are possible investments that represent the best of the best investments. The about 20 companies may have market validation, have multiple term sheets offered, the investment round is over-subscribed, the top tier VC is outside lead investor, and there is up-round valuation.

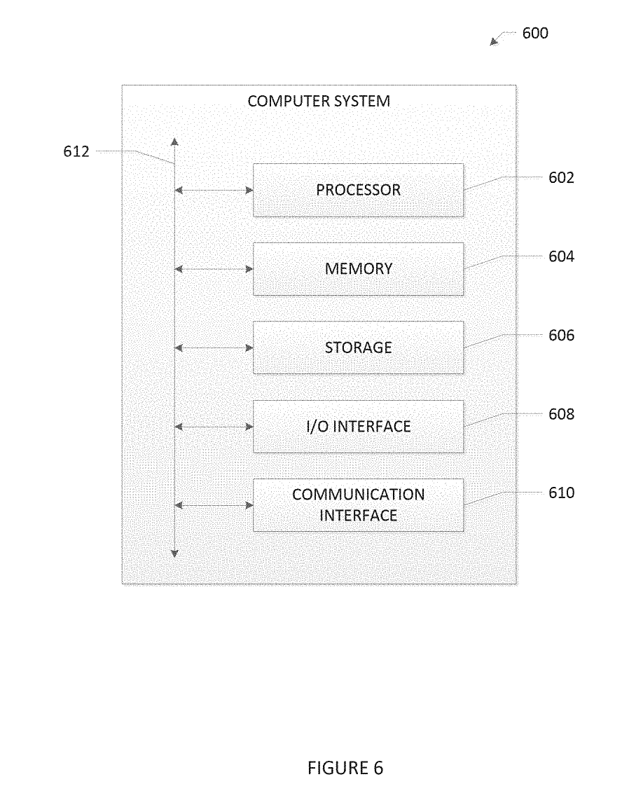

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600.

As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 600 may include one or more computer systems 600; be unitary or distributed; span multiple locations; span multiple machines; span multiple datacenters; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include an HDD, a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 65 U.S.C. § 101. Herein, reference to a computer-readable storage medium excludes transitory forms of signal transmission (such as a propagating electrical or electromagnetic signal per se) to the extent that they are not eligible for patent protection under 65 U.S.C. § 101. A computer-readable non-transitory storage medium may be volatile, non-volatile, or a combination of volatile and non-volatile, where appropriate.

This disclosure contemplates one or more computer-readable storage media implementing any suitable storage. In particular embodiments, a computer-readable storage medium implements one or more portions of processor 602 (such as, for example, one or more internal registers or caches), one or more portions of memory 604, one or more portions of storage 606, or a combination of these, where appropriate. In particular embodiments, a computer-readable storage medium implements RAM or ROM. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA. In particular embodiments, software is expressed in Hyper Text Markup Language (HTML), Extensible Markup Language (XML), or other suitable markup language.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage medium or media, or any suitable combination of two or more of these, where appropriate. A computer-readable non-transitory storage medium or media may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A private equity fund comprising:
a synthetic fund-of-funds residing on top of 20-50 other funds, wherein no actual investment is required and one or more of duplicate layer of fees, investment in early underperforming companies, and long J value are avoided; and
wherein fund level carry and deal level carry are combined.

2. The private equity fund of claim 1, wherein the synthetic fund-of-funds offers deal carry to one or more third parties, wherein the one or more third parties are venture capital funds or angels.

3. The private equity fund of claim 1, wherein the synthetic fund-of-funds comprises investments in underlying breakout companies via SPV 5 using Pro Rata.

4. The private equity fund of claim 1, wherein the synthetic fund-of-funds comprises a general partner that gains access to deals using pro rata rights of one or more of the 20-50 other funds.

5. The private equity fund of claim 1, wherein the synthetic fund-of-funds comprises a network venture capitalist on a board of directors.

6. The private equity fund of claim 1, wherein the synthetic fund-of-funds comprises a management fee that is shared.

7. The private equity fund of claim 1, wherein the synthetic fund-of-funds comprises additional fund level carry that is shared.

8. The private equity fund of claim 1, wherein the synthetic fund-of-funds comprises conditional pre-approval of an investment to a network venture capitalist, before the company has formally begun a raising around that is subject to at least one constraint, wherein the at least one constraint comprises valuation, outside lead, quality of load, and oversubscribed.
